(19) United States
(12) Patent Application Publication
(10) Pub. No.: US 2010/0227697 A1
(43) Pub. Date: Sep. 9, 2010

(54) FLEXIBLE COUPLING

(75) Inventor: Wayne A. Smith, Holland Patent, NY (US)

Correspondence Address: MARJAMA MULDOON BLASIAK & SULLIVAN LLP, 250 SOUTH CLINTON STREET, SUITE 300, SYRACUSE, NY, 13202, US

(73) Assignee: C-Flex Bearing Co., Inc.

(21) Appl. No.: 12/397,767

(22) Filed: Mar. 4, 2009

(51) Int. Cl. F16D 3/44

(52) U.S. Cl. 464/158

(57) ABSTRACT

According to the invention, a flexible coupling for flexibly coupling two rotating or moveable members, comprising a unitized body having a first end, a second end, and therebetween having two or more longitudinally (axially) spaced discs, wherein each disc can include a body portion and one or more spacer portions, wherein the spacer portions can extend longitudinally from an upper surface or lower surface of the body portion. The spacer portions can serve to axially space the body portions from each other and can also serve to unitize the discs and to space the unitized discs from the first and second end and can further serve to join the unitized discs to the first and second end.

### BACKGROUND OF THE INVENTION

The present invention relates to a flexible coupling for use in co-axially joining two rotating or moveable members, and more particularly to a manufactured flexible coupling utilized to join two rotating shafts, and which will allow angular, axial, and parallel misalignment while still transmitting torque between the two shafts.

Prior art flexible couplings, used for interconnecting a wide variety of rotating members, are offered in a variety of configurations to accommodate parallel, axial, and angular misalignments, while still transmitting torque between the driving and driven members. Two basic types are currently available, single and multi-piece flexible couplings. Single piece flexible couplings include radial, helical, and spiral slotted beam types, along with bellows and injection molded types. These types of couplings are either formed from a single piece of material, or are welded, brazed, or adhesive bonded into a single unitary construction. Multi-piece flexible couplings incorporate flexible metal discs or a non-metallic flexible material coupled to driving and driven ends. Flexible couplings of these prior art types, designed for high torsional stiffness and large torque capacity, cannot accept large misalignments without substantial reductions in life expectancy. Flexible couplings of these prior art types, designed for large misalignments, have low torsional stiffness and low torque capacity.

It is the object of this present invention to provide a novel flexible coupling which is economical to produce, while still having the capability to allow for large misalignments and cycle life with high torsional stiffness and torque capacity.

### BRIEF SUMMARY OF THE INVENTION

According to the invention, a flexible coupling for flexibly coupling two rotating or moveable members, comprising a unitized body having a first end, a second end, and therebetween having two or more longitudinally (axially) spaced discs, wherein each disc can include a body portion and one or more spacer portions, wherein the spacer portions can extend longitudinally from an upper surface or lower surface of the body portion. The spacer portions can serve to axially space the body portions from each other and can also serve to unitize the discs and to space the unitized discs from the first and second end and can further serve to join the unitized discs to the first and second end.

According to the invention, the discs can be joined to each other or first and second ends.

### BRIEF DESCRIPTION OF THE SEVERAL VIEWS OF THE DRAWING

Reference will be made in detail to various embodiments of the invention, which are illustrated in the accompanying drawing figures. The figures are intended to be illustrative, not limiting. Although the invention is generally described in the context of various embodiments, it should be understood that it is not intended to limit the scope of the invention to particular embodiments described.

Certain elements in selected views of the drawings may be illustrated not-to-scale, for illustrative clarity. Elements of the figures are numbered such that similar (including identical) elements may be referred to with similar numbers in a single drawing. Such relationships, if any, between similar elements in the same or different figures will become apparent throughout the specification, including, if applicable, in the claims and abstract.

The structure, operation, and advantages of the present preferred embodiment of the invention will become further apparent upon consideration of the following description taken in conjunction with the accompanying drawings, wherein:

FIG. 1 is a side view of a flexible coupling in vertical orientation showing two discs, each with a body portion and two spacer portions, and a first and second end;

FIG. 2 is an exploded perspective view of the flexible coupling of FIG. 1;

FIG. 3 is a side view of a disc with spacer portions;

FIG. 4 is a top view of the disc with spacer portions as shown in FIG. 3;

FIG. 5 is a cross sectional view taken along lines 5-5 of FIG. 4;

FIG. 6 is a perspective view of the disc and spacer portions shown in FIG. 3;

FIG. 7 is a side view of one embodiment of a disc with spacer portions;

FIG. 8 is a bottom perspective view of the disc shown in FIG. 7;

FIG. 9 is a top perspective view of the disc shown in FIG. 7;

FIG. 10 is a bottom view of the disc shown in FIG. 7;

FIG. 11 is an enlarged cross sectional view taken along lines 11-11 of FIG. 10;

FIG. 12 is an exploded view of the disc shown in FIG. 7;

FIG. 13 is a side view of a flexible coupling in vertical orientation showing five discs of one embodiment with spacer portions and a first and second end;

FIG. 14 is a bottom perspective view of a first end of the flexible coupling as shown in FIG. 13;

FIG. 15 is a top perspective view of a second end of the flexible coupling as shown in FIG. 13;

FIG. 16 is a perspective view of a flexible coupling shown in use coupling a driving member and a driven member.

### DETAILED DESCRIPTION OF THE INVENTION

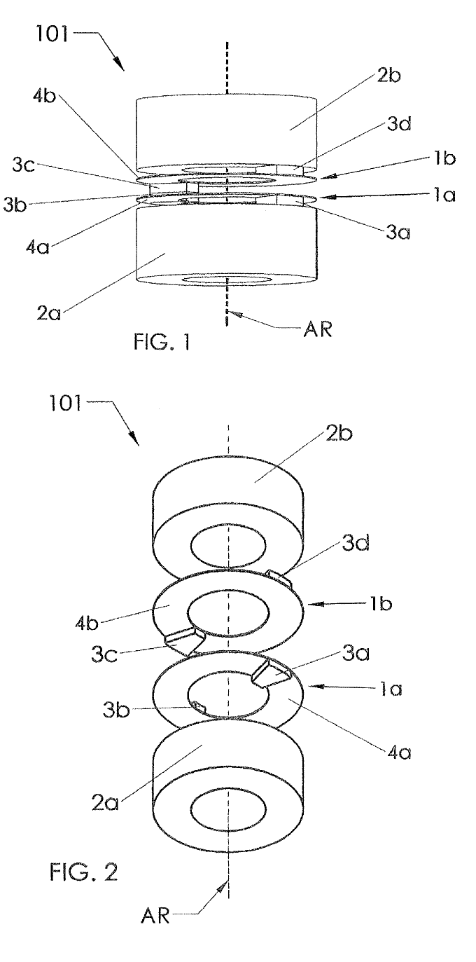

Referring now to FIG. 1 and FIG. 2, there is shown a flexible coupling 101 that is an embodiment of the present invention having two longitudinally (axially) spaced discs, between a first and second end. The orientation references described herein are selected arbitrarily as a matter of convenience to illustrate relative orientation of features in one embodiment, and that it will be understood that the described structure can be utilized in any orientation. As seen by the views of FIGS. 1 and 2, the flexible coupling 101 can have two discs 1a, 1b, (collectively referred to as discs), the discs being of multi-component construction including a body portion 4a, 4b, and spacer portions 3a, 3b, 3c, 3d (collectively referred to as spacer portions), the spacer portions extending longitudinally from an upper or lower surface of the body portion, where each spacer portion can be a non-contiguous component with respect to each other spacer portion, and where the body portion can be a non-contiguous component with respect to the spacer portions and where the spacer portions can be joined to the body portion to form a disc of unitized construction comprised of multiple components. The discs can be longitudinally spaced and joined to each other to form a unitized group of discs unitized with use of the spacer portions 3b, 3c, along axis of revolution AR. First and second ends 2a, 2b can be joined to the unitized group of discs through spacer portions 3a, 3d of discs 1a and 1b, along AR to complete the flexible coupling 101. All components of flexible coupling 101 can share a common axis of revolution AR, shown extending through the coupling 101. First and second ends 2a, 2b, which can be regarded as hubs serve as hubs for coaxially connecting each of the first and second ends 2a, 2b to a driving member and driven member respectively. The thickness and type of material utilized in the body portion can vary, as can the materials utilized for the spacer portions and first and second ends. In one embodiment, the material for the body portion can be high strength steel and the spacer portions and hubs can be plastic. In the embodiment of FIGS. 1 and 2, each disc spacer portion shown can be of unitary construction. Likewise, each disc body portion can be of unitary construction.

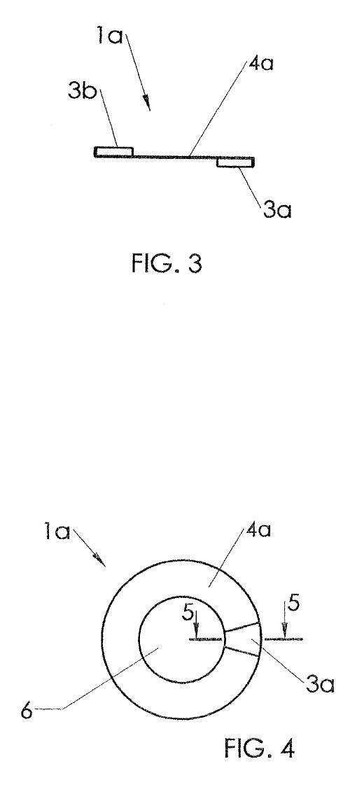

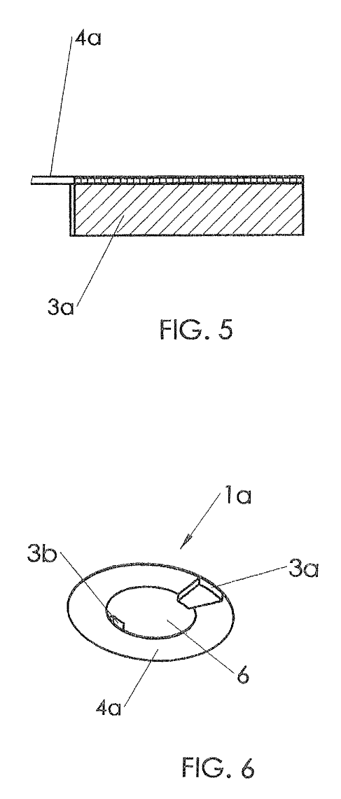

FIGS. 3 through 6 show a disc 1a with body portion 4a and spacer portions 3a, 3b. As shown in the views of FIGS. 3-6, body portion 4a can have an upper surface and a lower surface and, as is readily apparent from the drawings, spacer portion 3a can extend longitudinally from the lower surface of body portion 4a, while spacer portion 3b can extend longitudinally from the upper surface of body portion 4a. Spacer portions 3a and 3b can be rotationally offset from each other about AR, as shown in FIGS. 1 and 2, and spacer portions 3a and 3b can vary in number, shape, size, and rotational spacing. Disc 1a can have a center hole 6 which can be of varying size and shape to affect the stiffness and strength of the disc. The thickness and type of material utilized in the body portion can also vary, as can the materials utilized for the spacer portions. The body portion can be flat with an upper and lower surface, and these surfaces can be planar and parallel. In the embodiment described with reference to FIGS. 1 through 6, the described spacer portions can be joined to body portions by various methods including by adhesive bonding.

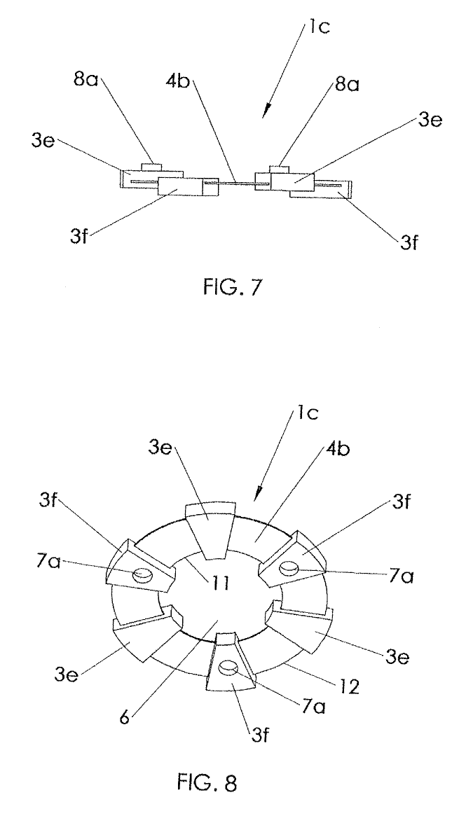

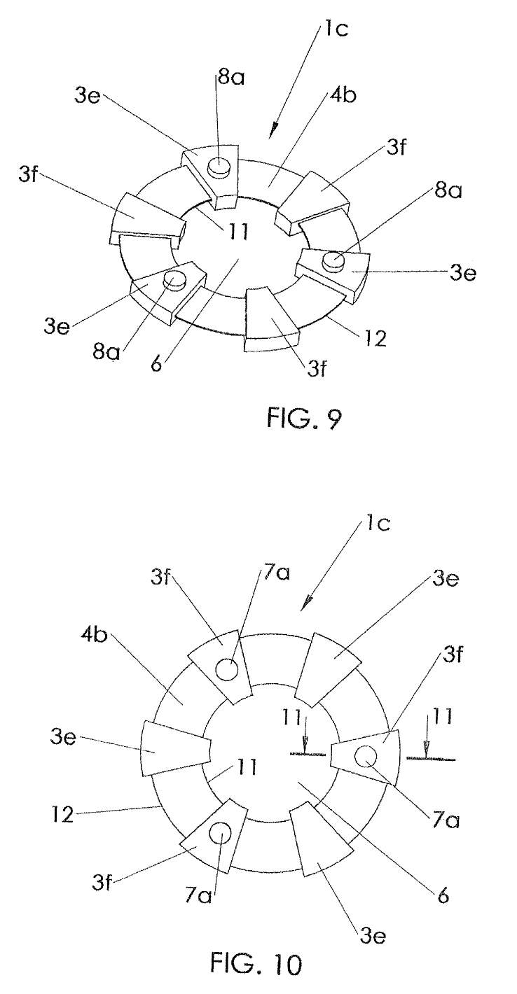

FIGS. 7-9 show another embodiment of a disc. In the embodiment of FIGS. 7-9, a disc 1c includes body portion 4b and spacer portions 3e and 3f. As seen by the views of FIGS. 7-9, spacer portions 3e and 3f can be radially disposed in equal proportions about the body portion 4b. Spacer portions 3e, which extend primarily longitudinally upward from the body portion, can include locating formations that can be provided by locating formations provided by raised locators 8a, while spacer portions 3f, which extend primarily longitudinally downward from the body portion, can include locating formations that can be provided by holes 7a. The raised locators 8a and holes 7a can be formed in such a way as to mate with each other. Such structure can ease assembly and joining of one disc to another, according to an assembly process one disc can be placed on top of another disc, rotated to align the bottom facing holes 7a of the top disc with the top facing raised locators 8a of the bottom disc, and the two discs can be aligned and joined as these two geometric features 7a and 8a mate. As seen in the embodiment of FIGS. 7-9, the spacer portions 3e can extend primarily longitudinally upward from the surface of the body portion, however, the spacer portions 3e can also extend slightly longitudinally downward from the lower surface of the body portion and contiguously slightly inward from the inner diameter 11 of the body portion and slightly outward from the outer diameter 12 of the body portion. Such a configuration allows for a complete encapsulation of the body portion 4b, by the spacer portion 3e. The same holds true for spacer portion 3f, however in an opposite longitudinal orientation to spacer 3e. In the embodiment of FIGS. 7 through 9, each disc spacer portion shown can be of unitary construction. Likewise, each disc body portion can be of unitary construction.

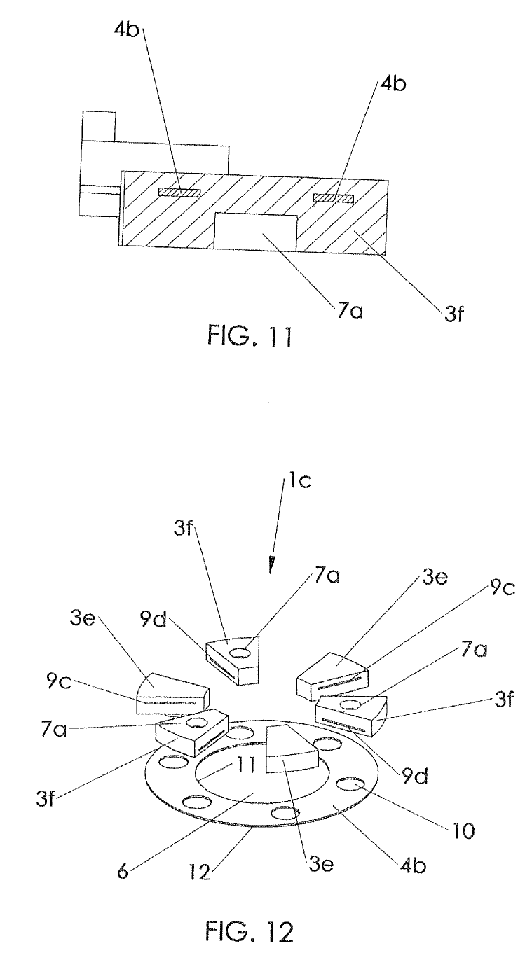

FIG. 11 shows a cross section through spacer portion 3f and body portion 4b, with hole 7a, as taken along lines 11-11 of FIG. 10, showing a complete encapsulation of the body portion by the spacer portion.

FIG. 12 shows an exploded perspective view of the disc shown in FIG. 7. As seen from the view of FIG. 12, the spacer portions 3e and 3f can be joined to the body portion 4b through slots 9c and 9d, the slots 9c and 9d representing the volumetric geometry of spacer portions 3e and 3f taken up by body portion 4b as the spacer portions encapsulate the body portion. In one embodiment, as will be described herein, spacer portions 3e and 3f can be injection molded about the body portion by way of a process of insert injection molding. As can be seen, the holes 10 in the body portion can be aligned with the spacer portions 3e and 3f, and allow the spacer portion to join contiguously to itself through hole 10 defined intermediate of an inner diameter 11 and an outer diameter 12 of spacer portion 4b, further strengthening its encapsulation of the body portion. Such result may be further observed in FIG. 11 as the spacer portion fully encapsulates the body portion.

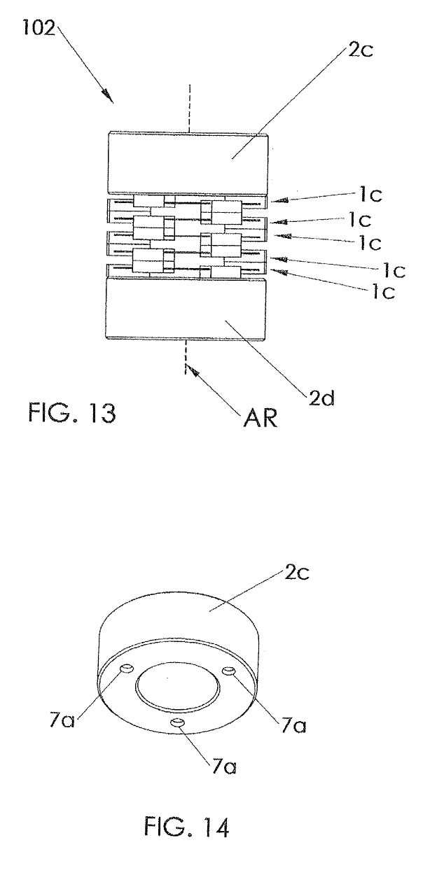

FIG. 13 shows an assembled flexible coupling 102 that is an embodiment of the present invention, having five longitudinally (axially) spaced discs between a first and second end, 2c and 2d. As seen by the embodiment of FIG. 13, the flexible coupling 102 can have, e.g., five discs 1c, (collectively referred to as discs). The discs can be aligned about AR and interlocked in an alternating manner utilizing locating formations e.g., the holes 7a and raised locators 8a of the spacer portions. The unitized group of discs can then be joined to the first and second end along AR utilizing the spacer portions in closest proximity to the first and second ends. The first and second ends can have locating formations, e.g., holes and raised locators identical to the features identified on spacer portions 3e and 3f to facilitate alignment, assembly, and joining of the first and second ends to the unitized group of discs.

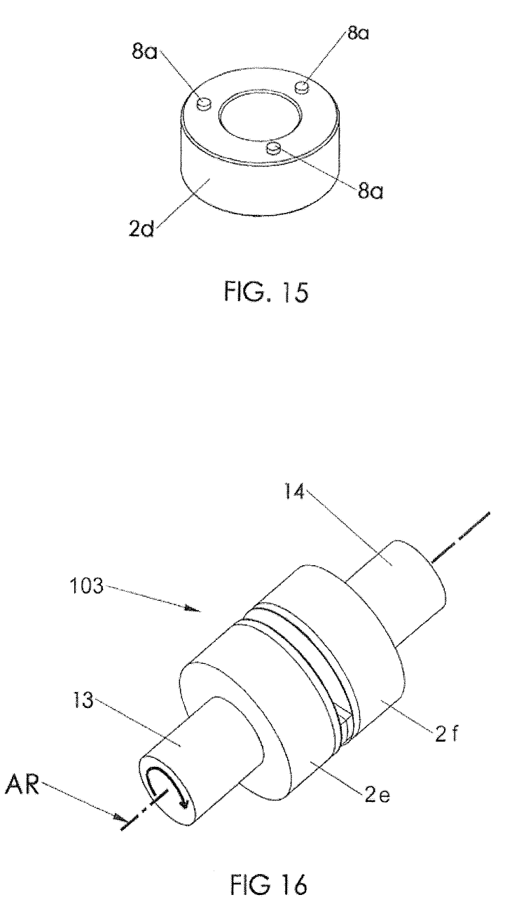

FIG. 14 and FIG. 15 show perspective views of first end 2c and second end 2d as seen by the views of FIGS. 14 and 15. First end 2c and second end 2d, which can be regarded as hubs, can include holes 7a and raised locators 8a respectively, which can be provided according to size and spacing of holes 7a and raised locators 8a of spacer portions 3e and 3f. The locating formations can facilitate alignment, assembly, and joining of the first and second ends to the unitized group of discs.

First hub 2c and second hub 2d can be adapted to be joined to a driving member 13 and a driven member 14, respectively. In one embodiment, the hubs can have cylindrical holes in them which can accommodate equivalent sized cylindrical driving and driven shafts, and set screws which can extend radially through each hub to clamp each hub to its respective driving or driven shaft.

FIG. 16 shows a flexible coupling 103 in use coupling a driving member and a driven member along an axis of rotation AR. Flexible coupling 103 can be provided in accordance with the embodiment described in connection with flexible coupling 101 or flexible coupling 102 or can comprise an alternative embodiment, e.g., can incorporate elements of both flexible coupling 101 and flexible coupling 102. Flexible coupling 103 can couple a driving member 13, supplying rotational power to a first end, and a driven member 14, which sees the rotational power provided by driving member 13 through a second end, as transmitted through flexible coupling 103. Hub 2e can be joined to driving member 13 and hub 2f can be coupled to driven member 14. In one embodiment, hub 2e can be provided in accordance with the embodiment described in connection with hub 2a. In another embodiment, hub 2e can be provided in accordance with the embodiment described in connection with hub 2c. In one embodiment, hub 2f can be provided in accordance with the embodiment described in connection hub 2b. In another embodiment, hub 2f can be provided in accordance with the embodiment of hub 2d. In one embodiment driving member 13 can represent the motor shaft of an electric motor, and the driven member 14, can represent the input shaft of a pump, for example.

Compared to prior art designs, the flexible coupling described herein in various embodiments offers great flexibility in the selection of materials and assembly methods to meet a variety of requirements. The multi-component feature of the described disc offers many advantages. For example, the multiple component disc feature allows the disc to be manufactured with high strength at reduced cost and with complex geometries which aid in the assembly of a complete flexible coupling having multiple discs.

The locating formations described herein that aid in the alignment of adjacent disc can be formed by a process of injection molding. Such process of injection molding can be simplified with reduced cost by injection molding a disc spacer portion of unitary construction as a non-contiguous component with respect to a disc body portion. In the embodiments shown, the disc body portion can be of simple construction and can be formed by way of a process of stamping. In one embodiment, the non-contiguous spacer portion and body portion components of a disc described herein can be of like or similar material, e.g., each spacer portion and each body portion can be metal, and in one particular embodiment, each spacer portion and each body portion of a disc can be formed of the same metal. In a particular embodiment, the spacer portions can be formed by way of metal injection molding.

In another embodiment, disc body portions as described herein can be formed of metal and disc spacer portions can be formed of plastic. The body portion, for example, can be a metal in the form of high strength steel, while the spacer portions can be formed of plastic. As plastic is well suited for injection molding, and because plastic injection molding technologies are well established, selection of plastic as a material for a component of a multi-component disc can yield additional cost and structural advantages. Plastic offers numerous advantages in the multi-component disc structure described herein. Injection molding the spacer portions allows locating formations of the spacers to be readily formed. Also utilizing insert injection molding (also known as overmolding) selection of plastic as a material for forming disc spacer portions allows for spacer portions to be molded around a metal insert, to fully or partially encapsulate that metal insert. The body portion of the disc can be high strength steel and would do the actual flexing, while the spacer portion of the disc would serve to rigidly join one disc to the next, or one disc to an end portion.

A suitable plastic for the spacer portions described herein is material from the product family sold under the trade name ZYTEL by DuPont. Material of the ZYTEL product line offers high strength, stiffness, durability, and chemical resistance, while maintaining excellent injection molding properties. Injection molding the spacer portions around the body portions allows the spacer portions to fully encapsulate the body portion, while at the same time creates location and assembly features such as holes or raised locators on the spacer portions which can mate during assembly.

Plastics of the ZYTEL product line that can be used to form spacer portions described herein include ZYTEL nylon resin and ZYTEL HTN, which is available in specific product number identifiers HTN51, HTN52, HTN53, HTN54.

A further advantage of utilizing plastic for the spacer portions is the ease with which spacer portions of adjacent discs may be joined together utilizing ultrasonic welding or adhesive bonding, both economical and high strength bonding techniques. The strength of such joining between spacer portions of adjacent discs can be increased by including on the spacer portions the locating formations as described herein. Locating formations as described herein, while aiding alignment, increase a surface area of an interface between spacer portion and a component joined thereto (e.g., a hub, a disc spacer portion, a disc body portion) as described herein.

The first and second ends can also be injection molded plastic, a process which can mold a complete part including a cylindrical bore suitable for joining to a driving or driven member, radial threaded holes for set screw clamping the first or second end to the driving or driven member, and locator features identical to those of the spacer portions to facilitate aligning assembling and joining the unitized discs to the first and second end.

The number of discs in embodiments described herein can easily be increased or decreased as determined by how much misalignment can be expected and how much torque must be transmitted. Also, the type and thickness of material utilized for the body portion can be varied to accommodate stiffness and torque requirements, as can the size, number, and spacing of the spacer portions. The present design, utilizing multi-component and multi-material configuration, offers significant cost advantages over existing products and designs, without sacrificing desirable performance characteristics.

While various particular embodiments have been described, it will be understood that the features and aspects described with reference to one particular embodiment described can be used with any other particular embodiment described.

While this invention has been described in the specification and illustrated in the drawings with respect to a preferred embodiment, it is understood that all changes and modifications that come within the spirit of the invention are desired to be protected. Undoubtedly, many variations or equivalents may be substituted for elements of the invention by one having ordinary skill in the art to which the present invention most nearly pertains, and such variations are intended to be within the scope of the invention; as disclosed herein.

1. A flexible coupling comprising:
a first hub and second hub;
a plurality of discs including a first disc and a second disc;
wherein the first disc is a multiple component construction, the multiple components of said first disc including a base portion and a plurality of spacer portions including a first and second spacer portion, each of the first and second spacer portions being radially spaced from one another and extending in a longitudinal direction from one or more of an upper surface or a lower surface of the base portion of the first disc;
wherein the second disc is also a multiple component construction, the multiple components of said second disc also including a base portion and plurality of spacer portions including a first and second spacer portion, each of the first and second spacer portions of said second disc being radially spaced from one another and extending in a longitudinal direction from one or more of an upper surface or lower surface of the base portion of the second disc;
wherein a disc of said plurality of discs adjacent said first hub is joined to said first hub;
wherein a disc of said plurality of discs adjacent said second hub is joined to said second hub; and
wherein the first disc is joined to said second disc; and
wherein said plurality of discs are coaxially aligned.

2. The flexible coupling of claim 1, wherein a base portion of said first disc comprises a material different from a material of said plurality of spacer portions of the first disc.

3. The flexible coupling of claim 1, wherein a spacer portion of said first disc is joined to a spacer portion of said second disc.

4. The flexible coupling of claim 1, wherein the first hub is adapted for joining a rotating driving member, wherein the second hub is adapted for joining a driven member.

5. The flexible coupling of claim 1, wherein said first spacer portion of said first disc is overmolded by injection molding onto said base portion.

6. The flexible coupling of claim 1, wherein said base member of said first disc comprises metal material and said first spacer portion of said first disc comprises non-metal material.

7. The flexible coupling of claim 1, wherein said base member of said first disc comprises metal material and said first spacer portion of said first disc comprises a material capable of being ultrasonically welded.

8. The flexible coupling of claim 1, wherein for joining of said first disc and said second disc, a spacer portion of said first disc is joined to a body portion of said second disc.

9. The flexible coupling of claim 1, wherein for joining of said first disc and said second disc, a spacer portion of said first disc is joined to a spacer portion of said second disc.

10. The flexible coupling of claim 1, wherein for joining of said first disc and said second disc, a spacer portion of said first disc ultrasonically welded to a spacer portion of said second disc.

11. The flexible coupling of claim 1, wherein a count of said plurality of discs is two.

12. The flexible coupling of claim 1, wherein a count of said plurality of discs is greater than two.

13. The flexible coupling of claim 1, wherein the body portions of said first disc are flat.

14. The flexible coupling of claim 1, wherein a count of said plurality of spacers of said first disc is two.

15. The flexible coupling of claim 1, wherein a count of said plurality of spacers of said first disc is three.

16. The flexible coupling of claim 1, wherein said first disc has a locating formation, and wherein said second disc has a locating formation, and wherein said locating formation of said first disc is adapted to mate with said locating formation of said second disc.

17. The flexible coupling of claim 16, wherein said locating formation of said first disc is provided by a protrusion and wherein said locating formation of said second disc is provided by a hole.

18. The flexible coupling of claim 1, wherein said first hub is adapted to be joined to one of a driving or driven member.

19. The flexible coupling of claim 1, wherein said flexible coupling is adapted to be joined to a rotating driving member and a driven member.

20. The flexible coupling of claim 1, wherein said flexible coupling is joined to a rotating driving member and to a driven member.

21. The flexible coupling of claim 1, wherein said body portion of said first disc has a hole, and wherein said first spacer portion of said first disc is contiguously formed through said hole of said first disc.
